(19) United States
(12) Patent Application Publication
(10) Pub. No.: US 2015/0106373 A1
(43) Pub. Date: Apr. 16, 2015

(54) GENERATING SEARCH DATABASE BASED ON EARTH'S MAGNETIC FIELD MEASUREMENTS

(71) Applicant: INDOORATLAS OY, Oulu (FI)

(72) Inventors: Janne HAVERINEN, Kiviniemi (FI); Mikko PERTTUNEN, Oulu (FI)

(21) Appl. No.: 14/054,264

(22) Filed: Oct. 15, 2013

(51) Int. Cl. G06F 17/30

(52) U.S. Cl. CPC G06F 17/30864; G06F 17/30598
USPC 707/737; 707/769

(57) ABSTRACT

There is provided a database entity for generating a search database, comprising: at least one processor and at least one memory including a computer program code, wherein the at least one memory and the computer program code are configured, with the at least one processor, to cause the database entity at least to: acquire, from each of the plurality of mobile devices, an indication of at least one object; acquire a reference Earth's magnetic field, EMF, fingerprint representing at least one of magnitude and direction of the EMF in a location and/or environment to which the at least one object is related to; associate each object with the corresponding reference EMF fingerprint; and generate a database of associations between the reference EMF fingerprints and the objects.

### FIELD

The invention relates generally to generating a database for search of objects from the internet. More particularly, the invention relates to the use of Earth's magnetic field measurements for generating such database and for performing such search.

### BACKGROUND

It is common to search information from the Internet by using, e.g. Google or Bing search engines. Typically this takes place by typing a search word or words, i.e. a search key, to the search engine and waiting for the search engine to retrieve results that are related to the typed search key. However, this type of search is limited in terms of, e.g., finding only those results that are directly related to the search words. For example, the search may retrieve objects, such as written documents or websites, including the typed search key.

### BRIEF DESCRIPTION OF THE INVENTION

According to an aspect of the invention, there are provided apparatuses as specified in claims 1, 17 and 19.

According to an aspect of the invention, there is provided a computer program product embodied on a distribution medium readable by a computer and comprising program instructions which, when loaded into an apparatus, cause the apparatus, such as the database entity, the mobile device or the user device, to execute any of the functionalities as described in the appended claims.

According to an aspect of the invention, there is provided a computer-readable distribution medium carrying the above-mentioned computer program product.

According to an aspect of the invention, there is provided an apparatus, such as the database entity, the mobile device or the user device, comprising means for performing any of the embodiments as described in the appended claims.

Some embodiments of the invention are defined in the dependent claims.

### LIST OF DRAWINGS

In the following, the invention will be described in greater detail with reference to the embodiments and the accompanying drawings, in which

FIG. 1 presents how a database may be generated, according to an embodiment;

FIG. 2 presents a method according to an embodiment;

FIGS. 3A and 3B illustrate example Earth's magnetic field (EMF) fingerprints;

FIG. 4 shows how a long EMF fingerprint may be divided, according to an embodiment;

FIG. 5 shows a method, according to an embodiment;

FIGS. 6A and 6B show how a search of objects may be performed, according to some embodiments;

FIGS. 7A to 7C illustrate three-dimensional orientation of the mobile device or of the user device;

FIGS. 8 and 9 show methods according to some embodiments; and

FIGS. 10 to 12 illustrate apparatuses according to embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As said earlier, current search methods from the Internet are limited. These may include, for example, typing a search key to the Google and waiting for the Google search engine to retrieve hits (such as links to documents or images) which comprise the given search key. The retrieved results are only related to the global search key. However, sometimes a person may want the search engine to retrieve any data/hits that is/are relevant to a certain local area. This provides more flexibility, user-friendliness and more possibilities for a search process.

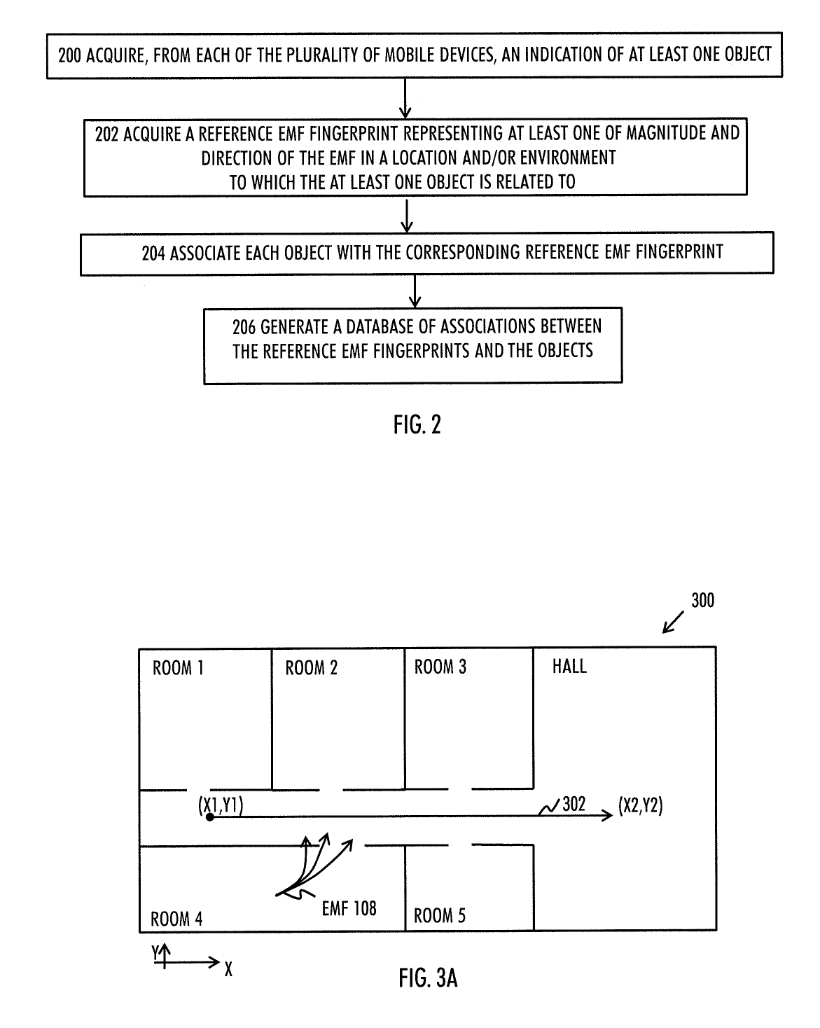

Therefore, there is provided a database entity 100, comprising at least one processor and at least one memory including a computer program code. According to the proposed solution, the at least one memory and the computer program code may be configured, with the at least one processor, to cause the database entity 100 to perform various functions. As shown in step 200 of FIG. 2, the database entity 100 may acquire, from each of a plurality of mobile devices 102-106, an indication of at least one object. In step 202, the database entity 100 may acquire a reference Earth's magnetic field, EMF, fingerprint representing at least one of magnitude and direction of the EMF in a location and/or environment to which the at least one object is related to.

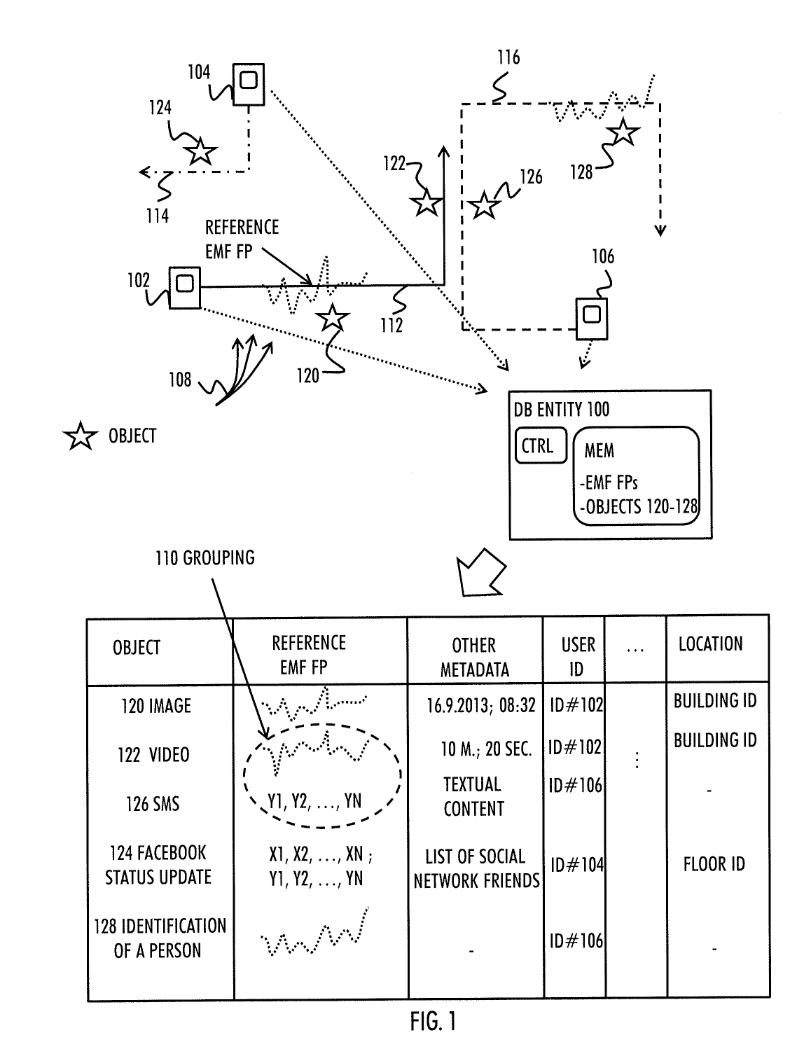

Before looking further at FIGS. 1 and 2, let us look at closer what an EMF fingerprint denotes. As known, global positioning system, GPS, location discovery may not be suitable for indoors due to lack of satellite reception coverage. For indoor based location tracking, RF based location discovery and location tracking may be used. In such system, a round trip time of the RF signal, or the power of the received RF signal, for example, may be determined to an indoor base station. However, these may require expensive measuring devices and equipment mounted throughout the building. As a further option, the utilization of the EMF may be applied. The material used for constructing the building may affect the EMF measurable indoors and also the EMF surrounding the indoor building. For example, steel, reinforced concrete, and electrical systems may affect the EMF. The EMF may vary significantly between different locations in the building and may therefore enable accurate location discovery and tracking inside the building based on the EMF local deviations inside the building. On the other hand, the equipment placed in a certain location in the building may not affect the EMF significantly compared to the effect caused by the building material, etc. Therefore, even if the layout and amount of equipment and/or furniture, etc., change, the measured EMF may not change significantly.

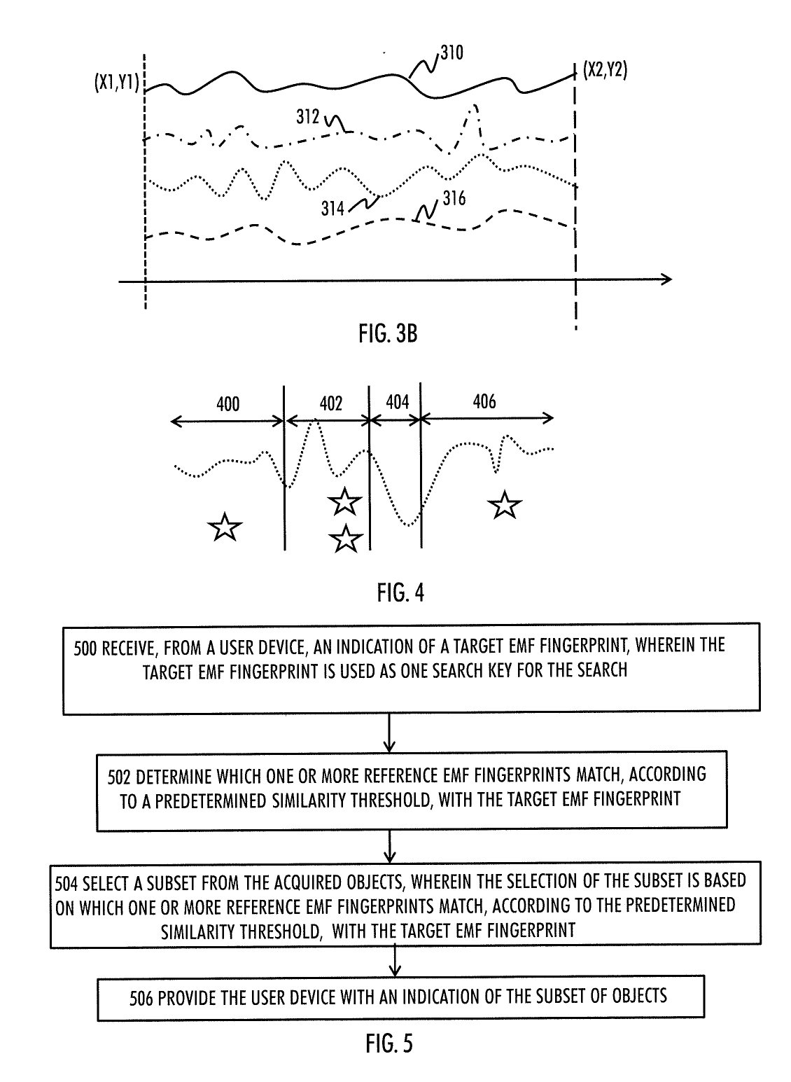

An example of a building 300 with 5 rooms, a corridor and a hall is depicted in FIG. 3A. It is to be noted that the embodiments of the invention are also applicable to other type of buildings, including multi-floor buildings, as well as outdoors. However, for the sake of simplicity, an indoor area is used as an example. A frame of reference of the building in the example of FIG. 3A may be an XY coordinate system, also known in this application as the world coordinate system. The coordinate system of the building 300 may also be three dimensional when vertical dimension needs to be taken into account. The vertical dimension is referred with Z, whereas X and Y together define a horizontal two-dimensional point (X, Y). In FIG. 3A, the arrow starting at a point (X1, Y1) and ending at a point (X2, Y2) may be seen as a path 302 traversed by a user.

The mobile device 102-106 is detailed later, but for now it may be said, that the mobile device 102-106 may comprise a magnetometer or any other sensor capable of measuring the EMF 108, such as a Hall sensor or a digital compass. The magnetometer may be an accurate sensor capable to detect any variations in the EMF 108. In addition to the strength, also known as magnitude, intensity or density, of the magnetic field (flux), the magnetometer may be capable of determining a three-dimensional direction of a measured EMF vector. To this end, it should be noted that at any location, the Earth's magnetic field 108 can be represented by a three-dimensional vector. Let us assume that a compass needle is tied at one end to a string such that the needle may rotate in any direction. The direction the needle points, is the direction of the Earth's magnetic field vector.

As said, the magnetometer carried by a person in the mobile device traversing the path 302 in FIG. 3A is capable of determining the three-dimensional magnetic field vector. Example three components of the EMF vector as well as the total strength are shown in FIG. 3B throughout the path 302 from (X1, Y1) to (X2, Y2). The solid line 310 may represent the total strength of the magnetic field vector and the three other lines 312 to 316 may represent the three components (X, Y, Z) of the three dimensional magnetic field vector. For example, the dot-dashed line 312 may represent the Z component (vertical component), the dotted line 314 may represent the X component, and the dashed line 316 may represent the Y component. From this information, the magnitude and direction of the measured magnetic field vector may be extracted.

FIG. 1 depicts some EMF fingerprints measured by the mobile devices 102 to 106. For the sake of clarity, the EMF fingerprints are shown only at two locations. However, in an embodiment, the mobile devices 102-106 measure the EMF 108 constantly. In an embodiment, the mobile devices 102 to 106 may transfer the measured EMF 108 to the database entity 100 constantly, as a continuous EMF fingerprint. In an embodiment, the mobile devices 102 to 106 may transfer the measured EMF 108 to the database entity 100 in parts as separated EMF fingerprints. In one embodiment, the mobile devices 102-106 perform the EMF measurement process as an automatic background process. In yet one embodiment, the mobile devices 102 to 106 measure the EMF 108 only temporarily at those locations where an object is detected.

The acquisition of the EMF fingerprint of step 202 may take place in various manners. In an embodiment, the database entity 100 may acquire the reference EMF fingerprint from each of the plurality of mobile devices 102-106. In this case, the reference EMF fingerprint may be measured by the mobile device at the location and/or environment in which the at least one object is detected by the mobile device. In an embodiment, the reference EMF fingerprint is acquired as part of a received digital content file representing the detected object from the mobile device. As an example, the reference EMF fingerprint may be stored as part of the digital content, such as the file format, of the detected object (e.g. an image, video, audio, as will be explained later). This may be beneficial as then the mobile device 102-106 need not separately transmit the fingerprint but it is stored as part of the digital content file of the detected object. This digital content file of the detected object may then be transmitted to the database entity 100 so that by receiving the object or an indication of the object, the database entity 100 simultaneously obtains the reference EMF fingerprint corresponding to this transmitted object. Alternatively, the database entity 100 may be authorized to access the object's stored digital content file in the mobile device.

In an embodiment, the database entity 100 may acquire the reference EMF fingerprint from another mobile device associated to the same user as the mobile device 102 from which the at least one object is acquired. For example, the person may carry a camera and a mobile phone. The camera may detect the object (e.g. capture an image) and the mobile phone may measure the reference EMF fingerprint. The devices may be configured to transmit the reference EMF fingerprint and the object to the database entity 100 or allow the database entity 100 to access the devices' contents via network. The database entity 100 may compare at least one predetermined comparison property of the acquired reference EMF fingerprint and of the acquired at least one object. Such property may be a time stamp when the object and the reference EMF fingerprint were detected/measured. The time stamp may be included in the file format of the object and of the reference EMF fingerprint. Another example property may be the location where the object and the reference EMF fingerprint were detected/measured, for example. The location may be detected with RF positioning system (such as Wi-Fi), satellite positioning system, EMF based positioning system, social media network (e.g. a status update indication the location of the mobile device), for example. The database entity 100 may acquire the indication of the location from the corresponding mobile device, e.g. as part of the file format of the object and of the reference EMF fingerprint.

Then the database entity 100 may associate the acquired reference EMF fingerprint with the acquired at least one object on the basis of the comparison. That is, if the property, such as the time stamp, is sufficiently similar, then the database entity 100 may determine that these correspond to each other. The location information may further aid in avoiding false associations. Whether the comparison property is sufficiently similar may be determined by applying a predetermined comparison threshold such that small deviations in the time stamps and/or location are allowed between one object-EMF fingerprint—association. This comparison threshold may be based on empirical derivation, for example. Further, there may an indication in one of the received data item (i.e. in the object or in the reference EMF fingerprint) according to which the received data item is to be associated with a data item (i.e. with the reference EMF fingerprint or with the object, respectively) received from a mobile device having a certain, indicated identifier.

These different devices of the same user may, in an embodiment, be connected together through, e.g. a short range communication connection, such as Bluetooth. This may allow the devices to transfer the object and/or reference EMF fingerprint between each other so that one device may perform the transmission of the object and the reference EMF fingerprint to the database entity 100.

In yet one embodiment, the database entity 100 may detect/identify the location of a given mobile device (e.g. the mobile device 102) among the plurality of mobile devices 102-106. The location may, as said, be detected with any positioning technique available. Thereafter, the database entity 100 may acquire the reference EMF fingerprint corresponding to the at least one object acquired from the mobile device on the basis of an EMF map of the area in which the mobile device is detected to locate. This embodiment may thus require that such EMF map is available. The EMF map refers to a map of the area, wherein the map comprises EMF magnitudes and/or directions for each location within the area. If such map is available, the database entity 100 may read the reference EMF fingerprint from the EMF map and associate the read EMF fingerprint with the at least one object acquired from this mobile device. The read reference EMF fingerprint may correspond to the most likely traversed path along which the object is detected (i.e. the along the identified location). For example, in a corridor, the reference EMF fingerprint may correspond to the EMF values along a predetermined spatial range along the corridor in the vicinity of the identified location.

Let us now consider the acquisition of the at least one object in step 200 of FIG. 2. The database entity 100 may have acquired, from each of the plurality of mobile devices 102-106, an indication of at least one object 120-128. Each object 120-128 may be related to the location/environment represented by the acquired reference EMF fingerprint. The objects 120-128 are marked in FIG. 1 with stars. In an embodiment, the object 120-128 may be detected by the mobile device 102-106 and the EMF fingerprint, corresponding to the location/environment where the object 120-128 was detected, may be automatically transmitted to the database entity 100 along with the indication of the detected object.

Let us consider, as an example, that an object is an image captured by the mobile device 102. It may be, for example, that the mobile device 102 transmits the captured images automatically to a cloud in the Internet for storing. Simultaneously, the mobile device 102 may also automatically transmit the corresponding EMF fingerprint to the cloud. It may be that the database entity 100 is comprised in the cloud or has access to the information stored in the cloud, so that the database entity 100 may acquire indication of the objects and of the EMF fingerprints from the cloud.

The indication of the object may comprise the content of the object (such as the image) or an indication where the content may be acquired.

An object may be anything that is related to the location and/or environment. Although the specification is written by defining that the object may be related to a location, the term “location” may be substituted with “environment”, such as an indoor and an outdoor environment. For example, in an embodiment, the object may be an image captured in the location corresponding to the EMF fingerprint. In an embodiment, the object may be an audio captured in the location. In an embodiment, the object may be a video captured in the location. In an embodiment, the mobile device 102-106 may capture the image, audio or video, and avail the object or an indication of the object and the corresponding EMF fingerprint to the database entity 100. This may take place by transmitting the object to the database entity 100 directly or allowing the database entity 100 to access the object data in the mobile device 102-106.

In an embodiment, the object may be an advertisement related to the location. The advertisement may be present in the location or the advertisement may be received at the location by the mobile device 102-106, such as a location specific mobile advertisement, for example. As the location specific mobile coupon or advertisement is received or detected (through a captured image, for example) by the mobile device 102-106, the mobile device 102-106 may provide an indication of the advertisement (i.e. of the detected object) to the database entity 100.

In an embodiment, the object may be any digital content detectable by the mobile device 102-106 the location/environment.

In an embodiment, the object may be identity of a person present in the location. The identity may be determined from images, audio, video, content of an electronic message (such as SMS, social media network message, email), social media network profile, or ID of the mobile device 102-106, for example. Thus, the person whose identity is determined may be the person carrying the mobile device, or another person present in the location, such as a person from which an image is captured at the location, or a person in a social network service.

In an embodiment, the object may be an operation performed in the mobile device at the location. The operation may be a status update in a social media network (Facebook, FourSquare, etc), transmission of a text message (SMS), a multimedia message, or an email, for example. In an embodiment, the object may be the content of an electronic message (text message, social media network message, multimedia message, email) sent or received in the location.

In an embodiment, the user of the mobile device 102-106 may himself/herself determine what is to be considered as an object. For example, the user of the mobile device 102-106 may determine that images and videos are comprised in the objects, whereas, for example, SMS messages are not. In another embodiment, the mobile device 102-106 may be pre-coded with instructions which determine those objects which are to be considered as objects. These objects may then be made available for the database entity 100, such as transmitted to the database entity 100 or to another entity to which the database entity 100 has access to or which transmits the indication of the objects to the database entity 100.

As said, in FIG. 1 the stars represent an object 120-128. For example, the mobile device 102 may travel a route 112 during which the mobile device 102 may detect two objects 120 and 122. As shown in the table of FIG. 1, let us consider that the object 120 is an image and the object 122 is a video clip. These may be automatically or manually send to the network, such as directly to the database entity or the database entity 100 may access this data from the server (cloud) to which these objects 120 and 122 were sent.

Let us further consider that the mobile device 104 may travel a route 114 during which the mobile device 104 may detect the object 124. As shown in the table of FIG. 1, let us consider that the object 124 is status update on Facebook, for example. The database entity 100 may fetch the status update automatically from the Facebook on the basis of the user ID of the person carrying the mobile device 104. In an embodiment, the mobile device 104 may allow the status updates to be accessed by the database entity 100. In an embodiment, the mobile device 104 may also transmit the content of the status update to the database entity 100.

The mobile device 106 may travel a route 116 during which the mobile device 102 may detect two objects 126 and 128. As shown in the table of FIG. 1, let us consider that the object 126 is an electronic message sent/received and the object 128 is an identification of a person in the location.

The database entity 100 may, as said earlier, receive in step 202 the indication of the reference EMF fingerprint corresponding to the location in which the object is detected. The reference EMF fingerprint may be given as a vector comprising numerical values representing the measured amplitude (Y1; Y2; . . . ; YN) and/or direction (Y1, X1; Y2, X2; . . . ; YN, XN) of the EMF as a function of distance or time. As a result, a graphical presentation of the measured reference EMF fingerprint may be provided. Each reference EMF fingerprint denotes a certain time window or a certain distance window around the time point or physical location, respectively, where the object was detected. In an embodiment, the window starts a predetermined duration/distance before the object is detected and ends when the object is detected. In another embodiment, the window starts when the object is detected and ends a predetermined duration/distance after the object has been detected. In yet one embodiment, the window starts a predetermined duration/distance before the object is detected and ends a predetermined duration/distance after the object has been detected.

In one embodiment, the length of each EMF fingerprint may be determined on a case-by-case basis by the database entity 100 or by the mobile device 102-106. This may be beneficial in order to make sure that each EMF fingerprint comprises distinguishing characteristics. These distinguishing characteristics may refer to statistical characteristics of the EMF fingerprint vector. For example, it may be that the variation of the amplitude samples and/or direction samples of the EMF fingerprint is required to be above a predetermined threshold, which may be empirically or mathematically derived. These distinguishing characteristics/features may aid in distinguishing the plurality of EMF fingerprints from each other.

In an embodiment, as shown in FIG. 4, the database entity 100 may divide the acquired reference EMF fingerprint into parts. This may be appropriate, e.g., when the mobile device 102-106 constantly transmits the EMF data to the database server 100 or otherwise transmits a long EMF fingerprint corresponding to more than one physically separated object. Let us further consider that the mobile device 102-106 transmits indications of the objects as the objects are detected. In such case, the database entity 100 may split the continuous or otherwise long EMF fingerprint into parts 400-406, wherein at least one part 400, 402, 406 may correspond to at least one detected object. Thereafter, the database entity 100 may associate the at least one part 400, 402, 406 with at least one object and consider each of these part(s) 400, 402, 406 as a separate reference EMF fingerprint.

In an embodiment, it may also be that the duration for an EMF fingerprint may be limited. Limiting the length may be beneficial so as to reduce the amount of memory storage needed from the database entity. The limitation may be automatic on the basis of a maximum duration or distance set for any EMF fingerprint. In another embodiment, the limitation may be determined case-by-case so that if a shorter EMF fingerprint already comprises distinguishing features, then there may not be any need to store an EMF fingerprint of the maximum length. In such case, there may be parts of the continuous EMF fingerprint which do not correspond to any object, such as the part 404 in FIG. 4.

Thereafter, in step 204, the database entity 100 may associate each object with the corresponding reference EMF fingerprint and in step 206 generate a database of associations between the reference EMF fingerprints and the objects. This is shown in the table of FIG. 1 in which the objects and reference EMF fingerprints on the same row are associated together. This type of database, which is shown in FIG. 1 as a table merely for the sake of simplicity, may then be used for various purposes. For example, the database entity 100 may perform searches from the database or organize objects in the database on the basis of the reference EMF fingerprints, as will be described.

In an embodiment, the objects may be categorized or grouped as outdoor objects and indoor objects on the basis of the reference EMF fingerprints. It may be that an EMF fingerprint from an outside area is different (e.g. the statistical variance may be smaller) than an EMF fingerprint from an indoor area. For example, the objects are categorized/grouped/clustered according to the similarities of the reference EMF fingerprints of features derived thereof.

In an embodiment, more detailed information about where the objects are actually detected, such as trains, subways, elevators, etc., may be acquired by the database entity. Thereafter, the database entity 100 may notice that a given group, comprise objects which are actually measured in one specific type of environment, such as in subways. This detection may be used by the database entity 100 to obtain knowledge about which environments, other than the previously mentioned indoor or outdoor environments, provide environment-specific EMF fingerprints.

In an embodiment, as shown in FIG. 1 with reference numeral 110, the database entity 100 may group the objects on the basis of the similarity of the reference EMF fingerprints. As earlier explained, the reference EMF fingerprints represent the unknown location/environment of the detected objects. Therefore, grouping the objects on the basis of the similarity of the EMF fingerprints simultaneously groups the objects locating in the same unknown location together. There may be a predetermined criterion with respect to the similarity of the reference EMF fingerprints. The criterion may be empirically or mathematically derived. The criterion may set requirements for how similar the reference EMF fingerprints or feature(s) derived from the fingerprints need to be in order for them to be combined. For example, the requirements may be set with respect to a statistical property between the reference EMF fingerprints, such as with respect to variances, frequency spectrum, amplitudes, peak-to-peak values, etc. In FIG. 1, it is assumed that the reference EMF fingerprints corresponding to objects 122 and 126 are grouped together because these reference EMF fingerprints are sufficiently similar. Looking at the map of FIG. 1, it may be detected that the objects 122 and 126 are located relatively close to each other and, thus, the corresponding EMF fingerprints are similar enough for the grouping.

Let us, as an example, assume that objects 122, 124 and 126 are objects which are detected outside. That is, the mobile devices, when detecting these objects 124-126 are located outside. On the contrary, objects 120 and 128 are located indoors. In such case, the grouping/categorizing may result in grouping the outdoor objects 122-126 in one group and grouping the indoor objects 120 and 128 in another group. This may provide a possibility to search for objects that are related to outdoors and/or to search for objects that are related to indoors. Although explained that, e.g., the outdoor environment may be an environment which may provide EMF fingerprints having similar properties so that objects from outdoor environments may be grouped together and distinguished from other environments, such as indoor environments, there may be other environments such as transportation types (subway, elevators, escalators) which provide similar possibilities. Further environment or sub-environment providing environment-specific EMF fingerprints for categorizing the corresponding objects may be, e.g., sea (EMF fingerprints measured in or above a sea in a boat, for example), mountain environments, for example.

In an embodiment, the exact location corresponding to the reference EMF fingerprint is not known, and an EMF map does not exist. However, in this embodiment, where the EMF map is not known, the database entity 100 may not know where the mobile devices 102-106, and consequently where the detected objects, are. As such specific location information is not known, it may be beneficial that the reference EMF fingerprints are collected so that the detected objects may be categorized or grouped or clustered or indexed according to the reference EMF fingerprint or feature(s) derived from it which represent the locations/environments/environmental conditions of the detected objects.

However, in another embodiment, the EMF map is known and the exact location of the mobile devices 102-106 may be determined on the basis of the reference EMF fingerprint and the EMF map. In this embodiment, the detected objects may be, with an increased reliability, associated with specific locations.

In an embodiment, the mobile devices 102-106 transmit and, thus, the database entity 100 acquires reference metadata from at least one of the mobile devices 102-106. The reference metadata may be determined by the mobile device 102-106 or the metadata may be determined by the database entity 100 on the basis of information related to the mobile devices 102-106. However, acquiring the metadata is not mandatory.

In an embodiment, the reference metadata comprises the measured EMF fingerprint. The EMF fingerprint may be stored in the digital content of the digital file representing the object (such as the captured image).

In an embodiment, the reference metadata comprises time and/or date when the reference EMF fingerprint was measured. This may be determined by the mobile device 102-106 or by the database entity 100. As shown, the table of FIG. 1 comprises the time/date for the object 120.

In an embodiment, the reference metadata comprises duration or distance corresponding to the reference EMF fingerprint. This may be determined by the mobile device 102-106, for example, and indicated to the database entity 100. Alternatively, the database entity 100 may determine this information on the basis of timing data or motion data obtained from the corresponding mobile devices 102-106. For example, the duration or distance corresponding to the reference EMF fingerprint may be determined on the basis of the motion data comprising inertial sensor data measured by the mobile device 102-106 during the measurement of the reference EMF fingerprint. As shown, the table of FIG. 1 comprises the distance/duration time/date for the object 122.

In an embodiment, the reference metadata comprises indication of the location in which the reference EMF fingerprint was measured. This may be determined on the basis of any location discovery technique, such as a location discovery technique applying radio frequency (RF) signals (e.g. the strength of received signals), magnetic fields, satellite positioning system, etc). As shown, the table of FIG. 1 comprises the location for the objects 120, 122 and 124.

In an embodiment, the reference metadata comprises a reference to a social media network of a person associated with the mobile device. The mobile device 102-106 may allow the database entity 100 to access the list of Facebook friends of the person, for example. As shown, the table of FIG. 1 comprises a list of Facebook friends for the object 124.

In an embodiment, the reference metadata comprises a type of each of the at least one object detected. The type may indicate whether the object is an object having a textual content, an image, a video, an electronic message, etc.

In an embodiment, the metadata comprises the type and/or model of the mobile device 102-106 used for the measuring the reference EMF fingerprint. This may be beneficial as the database entity 100 may be aware of bias associated with a specific type/model. If this is the case, the EMF fingerprint may correct the received reference EMF fingerprint from that mobile device so that all the reference EMF fingerprints are comparable with each other (i.e. the reference EMF fingerprints are made commensurable).

In an embodiment, the metadata comprises the user identification of the person associated with mobile device 102-106 which transmitted the detected object. Such indication may be obtained by the database entity 100 from any identifier (ID) transmitted by the mobile device. For example, the message carrying the indication of the detected object may carry also such globally unique ID. The unique ID may be related to the subscriber identity card (SIM) of the mobile device, for example. As shown, the table of FIG. 1 comprises the user ID for all the objects 120-128.

Thereafter, the database entity 100 may associate the acquired reference metadata with the at least one object indicated by the corresponding at least one mobile device 102-106. Again, such association is shown, for example, in the table of FIG. 1, wherein all objects and metadata on the same rows are associated with each other.

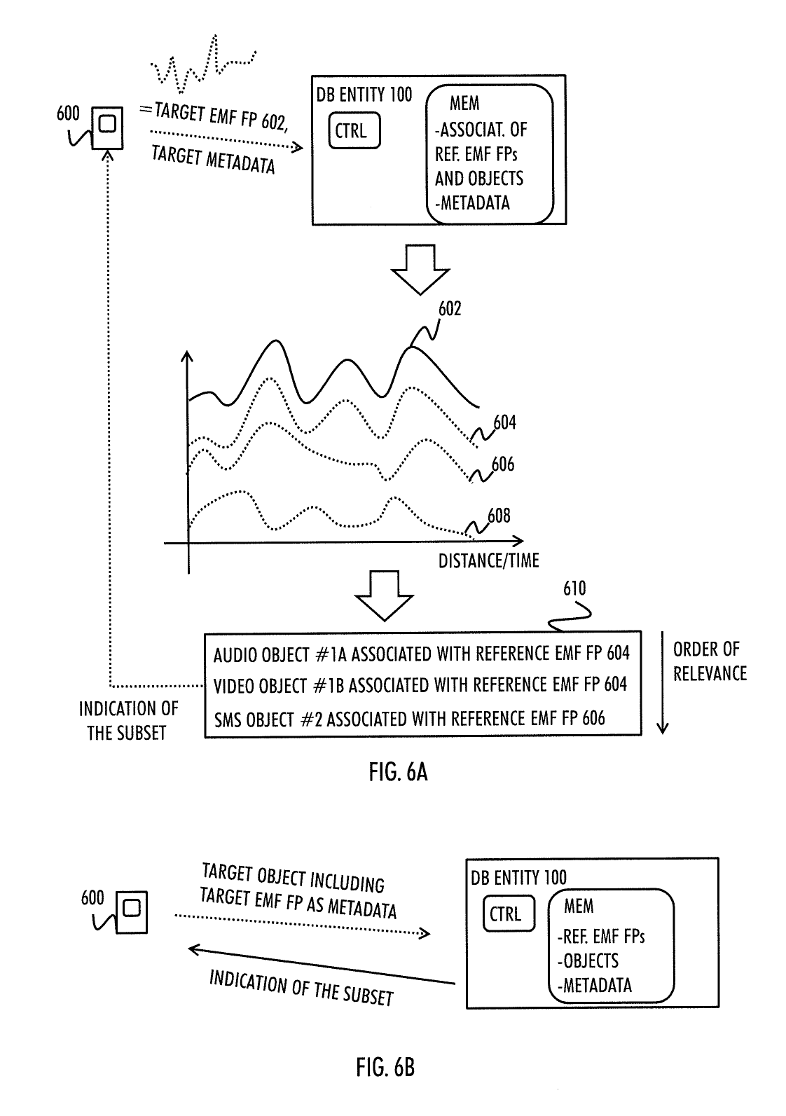

Let us now look at how the database entity 100 may serve as a search engine. As shown in FIGS. 5 and 6A/6B, the database entity 100 may, in step 500, receive, from a user device 600, an indication of a target EMF fingerprint 602, wherein the target EMF fingerprint 602 is used as one search key for the search. The indication of the target EMF fingerprint 602 may be given as a vector of values representing the magnitude and/or direction of the target EMF or a feature derived from the target EMF. In an embodiment, the user device 600 transmits the target EMF fingerprint 602 to the database entity 100. In an embodiment, the target EMF fingerprint 602 may be user defined. In an embodiment, the user device 600 may have measured the target EMF fingerprint 602. In an embodiment, the target EMF fingerprint 602 may be otherwise determined (e.g. by mathematical input, by drawing, etc.).

In one embodiment, the database entity 100 receive, from the user device 600, an indication of a target object, wherein the target object is associated with the target EMF fingerprint 602 and the target object indicates the target EMF fingerprint to the database entity 100. The target EMF fingerprint 602 may be embedded into the target object implicitly or explicitly. The target EMF 602 may be embedded in the digital content of the file representing the target object, for example, as shown in FIG. 6B. In an embodiment, the person carrying the user device 600 may not even know that the target object is associated with the target EMF fingerprint 602. The person may, for example, transmit the target object, such as an image, to the Instagram social media service. The target EMF fingerprint 602 may be embedded in the message carrying the image and may thus be acquired by the database entity 100 either directly from the user device or from the Instagram.

Thereafter, in step 502, the database entity 100 may determine which one or more reference EMF fingerprints 604-608 match, according to a predetermined similarity threshold, with the target EMF fingerprint 602. Such similarity threshold may be empirically or mathematically derived and may represent, for example, similarity in at least one statistical property between the fingerprint 602 and the fingerprints 604-608. An example statistical feature/property/characteristic may be the variance, peak-to-peak amplitude, mean value, mean deviation, frequency spectrum, N-dimensional feature (e.g. in time and/or in frequency domain) vector derived from the target fingerprint, etc. The comparison between the fingerprints 602-608 may be performed with respect to the magnitude and/or direction of the EMF represented by the fingerprints 602-608. It should be noted that the fingerprints 602-608 may be represented with numerical vectors. For the sake of illustration, graphical presentations are used in the Figures.

The comparison may comprise a graphical comparison of the graphical target and reference EMF fingerprint curves, a comparison between numerical values of the target and reference EMF fingerprints, a comparison between statistical features derived from the target and reference EMF fingerprints, etc.

Let us consider in FIG. 6A that the reference EMF fingerprints 604 and 608 are determined to have sufficient similarity (above the similarity threshold) with the target EMF fingerprint 602. However, the reference EMF fingerprint 608 may be determined not to match with the target EMF fingerprint 602. It should be noted that for the sake of simplicity of the illustration, the fingerprints 602 to 608 have been separated from each other.

In step 504, the database entity 100 may select a subset 610 from the acquired objects, wherein the selection of the subset 610 is based on which one or more reference EMF fingerprints match, according to the predetermined similarity threshold, with the target EMF fingerprint. As said, in an embodiment, the match need not be a perfect match. In an embodiment, the whether the fingerprints match or not may be based on determining a distance between features derived from the fingerprints. The subset 610 may comprise one or more of the acquired objects. In an embodiment, as a result, the subset 610 may comprise those objects which are associated with the one or more reference EMF fingerprints 604, 606 that match with the target EMF fingerprint 602. As shown, the subset 610 may comprise two objects (#1A, #1B), such as audio and video files, associated with the reference EMF fingerprint 604 and one object (#2), such as a transmitted/received SMS, associated with the reference EMF fingerprint 606. The object(s) associated with the reference EMF fingerprint 608 may not be comprised in the list. These objects in the subset 610 may correspond to those detected objects which are relevant to the, possibly unknown, location/environment specified by the target EMF fingerprint 602. For example, the objects in the subset 610 may be images captured at that location, or contents of electronic messages received or transmitted at that location. In other words, the subset 610 may comprise objects of a plurality of different types.

In an embodiment, upon selecting the subset 610 of the objects, the database entity 100 may select at least one of the groups/clusters, in case the grouping 110 which is illustrated in FIG. 1 has been performed earlier. This simplifies the procedure and speeds up the search of objects as the comparison of the target EMF fingerprint 602 needs to be made only once for each group/cluster, and not separately for each reference EMF fingerprint 604-608.

In step 506, the database entity 100 may then provide the user device 600 with an indication of the subset 610 of objects. The indication may be given in a form of a list of objects, or in any other manner readable by the user device 600. The user device 600 may then display the indication of the objects on a display of the user device 600. In this way, the database entity 100 returns, as a response to the search key from the user device 600, a list of relevant objects or a list of references to the objects associated to the location/environment specified by the search key.

In an embodiment, the database entity 100 may arrange the subset 610 according to a predetermined arrangement criterion, wherein the predetermined arrangement criterion comprises at least one of: relevancy on the basis of the match/distance between the target EMF fingerprint 602 and the reference EMF fingerprint 604-608 or between features derived thereof, date of the reference EMF fingerprint 604-608, reliability of the reference EMF fingerprint 604-608. For example, the objects in the subset 610 may be ordered so that the one which is associated to that reference EMF fingerprint 604, which provides the closest match with the target EMF fingerprint 602, may be the first in the subset 610. The one which is associated to that reference EMF fingerprint 606, which provides the furthest match with the target EMF fingerprint 602 but is still within the similarity threshold, may be the last in the subset 610. In another example, the object which is associated with that reference EMF fingerprint, which is most recently measured, may be the first in the subset 610. In another example, the object which is associated with the reference EMF fingerprint, which is most recently measured, may be the first in the subset 610.

In yet one embodiment, the object which is associated with that reference EMF fingerprint, which is most reliable, is the first in the subset 610. The reliability may be determined according to various criteria, including the age of the measured reference EMF fingerprint, the history information of the mobile device 102-106 which measured the reference EMF fingerprint (for example, if inaccurate EMF vectors has previously been received from this mobile device 102-106, then the reliability is not the best), the type and/or model of the mobile device 102-106 which measured the reference EMF fingerprint (e.g. some type/model may be known to cause inaccurate EMF measurements), and/or the stability/motion of the mobile device 102-106 during the EMF measurement (this may be detectable from motion data acquired from the corresponding mobile device 102-106).

In one embodiment, the database entity 100 may acquire an indication of target metadata, wherein the target metadata is further used as one search key for the search. Then the database entity 100 may select the subset 610 from the acquired objects, wherein the selection of the subset 610 is further based on comparison between the indicated target metadata and the reference metadata (see FIG. 1) associated with the objects. As a result, in this case the subset 610 may comprise fewer objects than in case where the target metadata is not taken into account.

In an embodiment, the target metadata may comprise a time frame with which the reference EMF fingerprint 604-608 is required to match. This may limit the selection so that only those objects which are associated with reference EMF fingerprints having a time stamp within the indicated time frame (such as within the last month) are listed in the subset 610. For example, all the objects associated with reference EMF fingerprints measured outside the given time frame are not comprised of the subset 610.

In an embodiment, the target metadata may comprise a reference to a social media network. In this embodiment, the subset 610 may be limited so that only those objects which are related to the indicated reference are comprised in the subset 610. Such reference may be, e.g. a list of friends in the social media network of the person carrying the user device 600. Then, only those images, messages, videos, etc., which are related to the indicated reference (such as comprise the name or image of at least one of the person's friends) are comprised in the subset 610.

In an embodiment, the target metadata may comprise duration and/or distance corresponding to the target EMF fingerprint 602. This may aid in making the target EMF fingerprint 602 and the reference EMF fingerprints 604-608 commensurable with each other. The distance may be obtained on the basis of motion data from the mobile device, for example.

In an embodiment, the target metadata may comprise type of the objects to be retrieved. In this case, only those objects which belong to the type of the target object are comprised in the subset 610.

In an embodiment, the database entity 100 may detect the geographical location in which the mobile device, e.g. the mobile device 104, is at the moment when the at least one object is acquired. This may be determined on the basis of a positioning system, such as satellite based system, RF signal based system, EMF based system, etc. Then the database entity 100 may associate each object with the corresponding geographical location. This is shown in FIG. 1 where the location of the object is given for at least some objects.

In an embodiment, data indication the location of the mobile device (i.e. location data) is stored as metadata in digital content file of the corresponding object so that the database entity 100 obtains this location data when it receives/accesses the file of the object.

Thereafter, the database entity 100 may acquire an indication of a target geographical area from the user terminal 600, wherein the target geographical area is further used as one search key for the search. The database entity 100 may then select the subset from the acquired objects, wherein the selection of the subset 610 is further based on which objects are associated with a geographical location within the indicated target geographical area. As a result, the subset 610 may comprise those objects which are associated with the one or more reference EMF fingerprints that match with the target EMF fingerprint and which are associated with a geographical location within the indicated target geographical area. This may be beneficial as there may be situations where the reference EMF fingerprint is somewhat similar even though they are measured in different locations. Then, obtaining the rough knowledge of the location of the location may be helpful in providing the user terminal 600 with the subset 610 of objects from only one location corresponding to the indicated target EMF fingerprint 602.

In an embodiment, the location or the area is indicated with an accuracy of one or more building or with an accuracy of one or more floors within a building. In an embodiment, the indication comprises satellite positioning system coordinates. In an embodiment, Wi-Fi is used for deriving the indication of the location or the area.

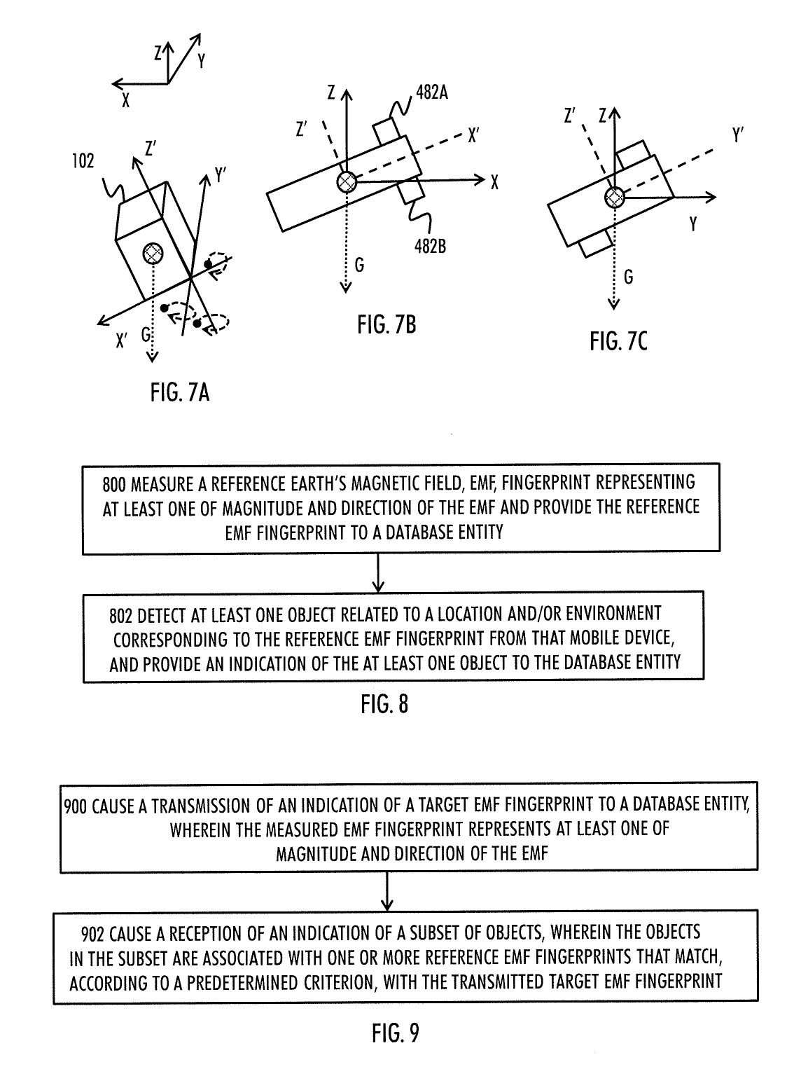

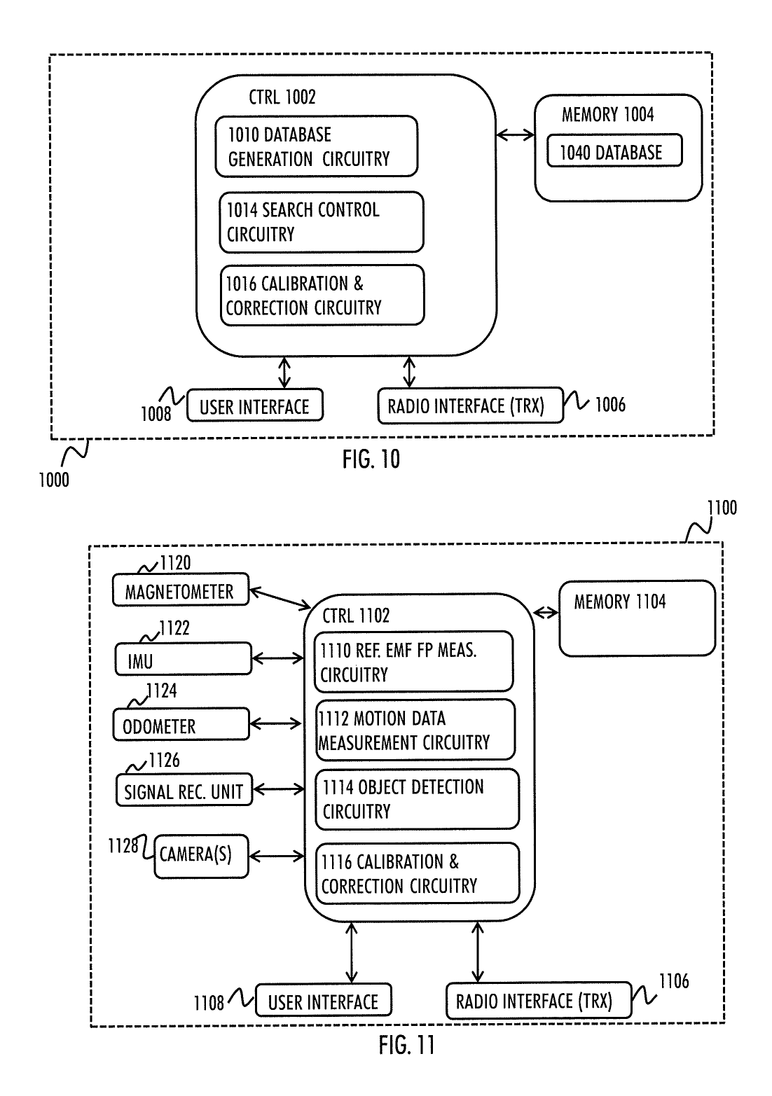

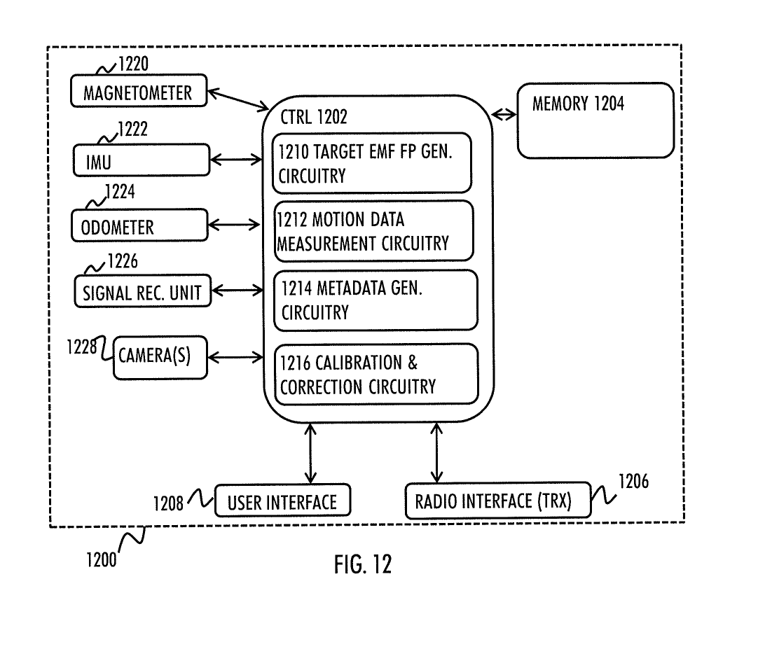

As shown in FIG. 7A, a person carrying the mobile device, such as the mobile device 102, may not all the time keep the mobile device 102 in correct angles with respect to the frame of reference of the person carrying the mobile device 102, represented with XYZ coordinates. The person may swing his arms and cause motion to the mobile device 102. In such case, the three dimensional orientation of the mobile device 102 may vary. In particular, the mobile device 102 may be rotated about at least one of the three axis X, Y and Z, as shown in FIG. 7A. This may lead to inaccurate EMF measurements being carried out by the mobile device 102 with respect to the direction of the EMF vector and, thus, lead to erroneous or inefficient location discovery and/or tracking or to erroneous or non-optimal initial location estimate. It should be noted that although observing the magnitude may in some cases be sufficient for detecting the change of the operational environment and/or for the location estimation/tracking, observing the direction may provide additional accuracy and efficiency. This is because more information, including the direction, may be utilized.

The three-dimensional orientation of the mobile device 102 may be defined by at least one of the following: a rotation with respect to a first horizontal axis (such as X-axis or Y-axis), a rotation with respect to a second horizontal axis (such as Y-axis or X-axis, respectively), and a rotation with respect to a vertical axis Z. Let us consider this in more detail by referring to FIG. 7. In FIG. 7, the solid arrows represent the world XYZ coordinate system and the dotted lines show the frame of reference of the mobile device 102. FIG. 7B shows how the mobile device 102 may be rotated about Y-axis. In FIG. 7B, the Y-axis points towards the paper. In FIG. 7C, the mobile device 102 is rotated about X-axis, which points towards the paper.

In an embodiment, the database entity 100 may acquire motion data of the mobile device 102, wherein the motion data is measured by the at least one inertial measurement unit (IMU) comprised in the mobile device 102 during the measurement of the reference EMF fingerprint. In an embodiment, the motion data is stored as metadata in digital content file of the corresponding object so that the database entity 100 obtains this motion data information when it receives/accesses the file of the object. The motion data may be used to represent the EMF fingerprints (either the reference or the target fingerprint) as a function of distance, instead of or in addition to the fingerprint being a function of time. This may further help in providing correct hits in the search.

Further, the motion data may indicate the three-dimensional orientation of the mobile device 102 at the at least one time instant when the reference EMF fingerprint is measured by the mobile device 102. The orientation, as shown in FIG. 7A, may be defined in the frame of reference (X′, Y′, Z′) of the mobile device 102. However, (X′, Y′, Z′) is not the same as (X, Y, Z). Thus, error may occur without adjusting/rotating/correcting the acquired EMF data from the frame of reference (X′, Y′, Z′) of the mobile device 102 to the frame of reference (X, Y, Z) of the person. It may be noted that the frame of reference (X, Y, Z) of the person may be assumed to correspond to the frame of reference of the floor plan of the building 300.

Thereafter, the database entity 100 may apply the inertial measurement results for determining, on the basis of the acquired motion data, at least one angle estimate of a difference between the three-dimensional orientation of the mobile device 102 and a three-dimensional coordinate system of the person carrying the mobile device 102. For example, in order to determine the amount of rotation about the Y-axis (FIG. 7B) and about X-axis (FIG. 7C), the mobile device may be in one embodiment equipped with an inertial measurement unit. The IMU may comprise at least one acceleration sensor utilizing a gravitational field. The IMU may optionally also comprise other inertial sensors, such as at least one gyroscope, for detecting angular velocities, for example. The acceleration sensor may be capable of detecting the gravitational force G. By detecting the acceleration component G caused by the Earth's gravitation in FIGS. 7B and 7C, the mobile device 102 may be able to determine the amount of rotation about axis X and/or Y. The rotation about the Z-axis may be compensated, e.g., by using the information given by the gyroscope, by using the information of a true direction of the EMF which may be based on the EMF map for the area, or by using information of a dominant movement direction (such as the movement direction of the person carrying the mobile device), wherein the dominant movement direction may be derived from the motion data from the mobile device. In an embodiment, the IMU may detect the movement of the person carrying the mobile device 102. This may advantageously allow, e.g., the speed and direction of the person to be determined. For further description about the correction of the unknown three dimensional orientation of the mobile device carried by a person may be found from U.S. patent application Ser. Nos. 13/739,640 and 13/905,655, the contents of which are incorporated herein by reference.

Finally, the database entity 100 may adjust the reference EMF fingerprint on the basis of the determined at least one angle estimate. This may be advantageous in order to commensurate the EMF fingerprints received from different mobile devices 102-106.

Also the target EMF fingerprint 602 may be adjusted in the similar manner if it is detected, for example on the basis of motion data acquired from the user device 600, that the three dimensional orientation of the user device 600 is not aligned with the axis of the XYZ coordinate system. In some cases it may be that the user defines the target EMF fingerprint 602 from a user interface on the user device 600. In this case, the user interface application of the user device 600 may make sure that the given target EMF fingerprint 602 represents the direction of the EMF in the desired coordinate system. However, in some other cases it may be that the user device 600 captures an image, transmits the captured image to the database entity 100 along with the target EMF fingerprint 602 associated with the captured image. Then it may be that the user device 600 has not been correctly oriented when it has measured the target EMF fingerprint 602 and/or may have moved during the measurement and, consequently, such target EMF fingerprint 602 may need to be corrected, as explained above.

Looking from the mobile device 102-106 point of view with respect to FIG. 8, the proposed system comprises that the mobile device in step 800 measures the reference EMF fingerprint representing at least one of magnitude and direction of the EMF and provides the reference EMF fingerprint to a database entity 100. In step 802, the mobile device may detect at least one object related to a location and/or environment corresponding to the reference EMF fingerprint from that mobile device, and provide an indication of the at least one object to the database entity, in order to allow the database entity 100 to associate each object with the corresponding reference EMF fingerprint, or with a feature derived from the reference EMF fingerprint, and maintain a database of the associations. In an embodiment, the reference EMF fingerprint is provided to the database entity 100 as part of a digital content file representing the detected object. The measurement of the reference EMF fingerprint may be automatically performed by the mobile device, such as by an application in the mobile device 102-106 which detects the at least one object. Such application may be, for example, a video recording application or an application for capturing images, transmitting electronic messages, etc.

Looking from the point of view of the user device 600 with respect to FIG. 9, the proposed system may comprise that the user device 600 causes in step 900 a transmission of an indication of a target EMF fingerprint to the database entity 100, wherein the measured EMF fingerprint represents at least one of magnitude and direction of the EMF. In step 902, the user device 600 may cause a reception of an indication of a subset 610 of objects, wherein the objects in the subset 610 are associated with one or more reference EMF fingerprints that match, according to the predetermined similarity threshold, with the transmitted target EMF fingerprint. Thereafter, the user device 600 may, for example, display the subset 610 of objects on a display of the user device 600. In one embodiment, the display is not needed but the user device 600 may utilize the results in an application executable in the user device 600. For example, in case the subset comprises images and indications on who took the images (identity of the persons), the application may display the users in the form of “You might like photos taken by the users ID#1, ID#2, . . . ”.

In one example embodiment, the user device 600 may capture an image by a camera application installed in the user device 600. The user device 600 may have also measured a target EMF fingerprint corresponding to the location in which the image was captured. The camera application may include the measured target EMF fingerprint to the data file of the image and send the data file to Instagram, for example. Additionally, target metadata may be added to the image data file (serving as the target object), as explained earlier. The user interface of the Instagram may be equipped with an input, such as a button, for “search objects from the location of the image”. Upon a person clicking the button in the Instagram, the Instagram may transmit the target EMF fingerprint to the database entity 100, which searches for objects in that area on the basis of the target EMF fingerprint and the plurality of reference EMF fingerprints. As a result, the database entity 100 may return the subset 610 of objects, which may comprise also other type of objects than only images, to the user device 600. This may take place either directly to the user device 600 or via the Instagram server. In case the person clicking the button in the user interface is not the person associated with the user device 600, the subset 610 may be transmitted to another device associated with the person clicking the button.

In another example embodiment, the user device 600 may run a search application, such as Google, or apply the web browser to access Google search page. The user of the user device 600 may enter, e.g., an image or a reference (e.g. URL) to an image in the search field. The digital file of the image may comprise the target EMF fingerprint 602 as metadata or the EMF fingerprint 602 may be separately indicated to the database entity 100. Based on this EMF target fingerprint 602 the database entity 100 may then search and retrieve from the database all objects that are associated with a similar enough (based on the similarity threshold) reference EMF fingerprint. These searched objects may be listed according to the predetermined arrangement criterion and then provide the user terminal 600 with the arranged search results. In an embodiment, the user of the user device 600 may limit the search by indicating the type of the objects to be retrieved, such as only audio, image, video, identifiers of persons, etc.

Embodiments, as shown in FIGS. 1012, provide apparatuses 1000, 1100, 1200. In an embodiment, the apparatus 1000 is or is comprised in the database entity 100, such as in a network server computer. In an embodiment, the apparatus 1100 is or is comprised in a mobile device 102-106, such as in a mobile phone, camera, smart phone, a laptop, or a tablet, for example. In an embodiment, the apparatus 1200 is or is comprised in a user device 600, such as in a mobile phone, smart phone, a laptop, a tablet, or a personal computer, for example. In an embodiment, the apparatus 1000, 1100, 1200 may be or comprise a module (to be attached to the respective device 100-108, 600) providing connectivity, such as a plug-in unit, an “USB dongle”, or any other kind of unit. The unit may be installed either inside or attached to the device 100-108, 600 with a connector or even wirelessly.

Each of the apparatuses comprise at least one processor 1002, 1102, 1202 and at least one memory 1004, 1104, 1204 including a computer program code, which are configured to cause the respective apparatuses (such as the database entity 100, the mobile devices 102-106, and the user device 600, respectively, to carry out functionalities according to any of the embodiments. The at least one processor may each be implemented with a separate digital signal processor provided with suitable software embedded on a computer readable medium, or with a separate logic circuit, such as an application specific integrated circuit (ASIC).

The apparatuses 1000, 1100, 1200 may further comprise radio interface components 1006, 1106, 1206 providing the respective apparatus with radio communication capabilities with the radio access network. The radio interfaces may be used to perform communication capabilities between the apparatuses. The radio interfaces may be used to communicate data related to the EMF fingerprints, detected objects, metadata, search results, location estimates, etc.

User interfaces 1008, 1108, 1208 may be used in operating the respective apparatuses. The user interfaces may each comprise buttons, a keyboard, means for receiving voice commands, such as microphone, touch buttons, slide buttons, etc.

The at least one processor 1002 may comprise a database generation circuitry 1010 for generating the database for the objects and the associated reference EMF fingerprints and, possibly, for the metadata. A search control circuitry 1012 may be for performing the search of the objects on the basis of the search keys. A calibration & correction circuitry 1014 may be responsible for correcting the received EMF fingerprints on the basis of the motion data, or on the basis of known bias, for example.

The at least one processor 1102 may comprise a reference EMF fingerprint generation circuitry 1110 for generating the reference EMF fingerprint with the help of the magnetometer 1120, a motion data measurement circuitry 1112 for measuring the motion data with the help of the IMU 1122 and/or the odometer 1124, an object detection circuitry 1114 for detecting objects and for generating reference metadata, and a calibration & correction circuitry 1116 for performing a calibration process of a magnetometer 1120 and/or correcting the acquired information from the magnetometer 1120, for example. A camera 1128 and microphones may be used for capturing images and/or video (e.g. objects), for example. A signal reception unit 1126 may be for detecting the presence of a proximity radio frequency signal, such as WiFi signal, or for detecting GPS signals, for example.

The at least one processor 1202 may comprise a target EMF fingerprint generation circuitry 1210 for generating the target EMF fingerprint with the help of the magnetometer 1220, a motion data measurement circuitry 1212 for measuring the motion data with the help of the IMU 1222 and/or the odometer 1224, a metadata generation circuitry 1214 for generating target metadata, and a calibration & correction circuitry 1216 for performing a calibration process of a magnetometer 1220 and/or correcting the acquired information from the magnetometer 1220, for example. A camera 1228 and microphones may be used for capturing images and/or video (e.g. target objects), for example. A signal reception unit 1226 may be for detecting the presence of a proximity radio frequency signal, such as WiFi signal, or for detecting GPS signals, for example.

The magnetometer 1120 and 1220 may comprise at least one orthogonal measuring axis. However, in an embodiment, the magnetometer may comprise three-dimensional measuring capabilities. Yet in one embodiment, the magnetometer may be a group magnetometer, or a magnetometer array which provides magnetic field observation simultaneously from multiple locations spaced apart.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a entity, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor and at least one memory including a computer program code, wherein the at least one memory and the computer program code are configured, with the at least one processor, to cause a database entity at least to:
acquire, from each of the plurality of mobile devices, an indication of at least one object;
acquire a reference Earth's magnetic field, EMF, fingerprint representing at least one of magnitude and direction of the EMF in a location and/or environment to which the at least one object is related to;
associate each object with the corresponding reference EMF fingerprint; and
generate a database of associations between the reference EMF fingerprints and the objects.

2. The apparatus of claim 1, wherein the object is at least one of the following: an image captured in the location/environment, an audio captured in the location/environment, a video captured in the location/environment, an advertisement related to the location/environment, identity of a person present in the location/environment, an operation performed in the mobile device at the location/environment, content of an electronic message sent or received in the location/environment.

3. The apparatus of claim 1, wherein the database entity is further caused to:
acquire, from each of the plurality of mobile devices, the reference EMF fingerprint, wherein the reference EMF fingerprint is measured by the mobile device.

4. The apparatus of claim 1, wherein the reference EMF fingerprint is acquired as part of a received digital content file representing the detected object from the mobile device.

5. The apparatus of claim 1, wherein the database entity is further caused to:
acquire the reference EMF fingerprint from another mobile device associated to the same user as the mobile device from which the at least one object is acquired;
compare at least one predetermined comparison property of the acquired reference EMF fingerprint and of the acquired at least one object; and
associate the acquired reference EMF fingerprint with the acquired at least one object on the basis of the comparison.

6. The apparatus of claim 1, wherein the database entity is further caused to:
detect the location of a given mobile device among the plurality of mobile devices; and
acquire the reference EMF fingerprint corresponding to the at least one object acquired from the mobile device on the basis of an EMF map of the area in which the mobile device is detected to locate.

7. The apparatus of claim 1, wherein the database entity is further caused to:
divide the acquired reference EMF fingerprint into parts; and
associate at least one part with at least one object and consider each of these at least one part as a separate reference EMF fingerprint.

8. The apparatus of claim 1, wherein the database entity is further caused to:
group the objects on the basis of the similarity of the reference EMF fingerprints.

9. The apparatus of claim 1, wherein the database entity is further caused to:
receive, from a user device, an indication of a target EMF fingerprint, wherein the target EMF fingerprint is used as one search key for the search;
determine which one or more reference EMF fingerprints match, according to a predetermined similarity threshold, with the target EMF fingerprint;
select a subset from the acquired objects, wherein the selection of the subset is based on which one or more reference EMF fingerprints match, according to the predetermined similarity threshold, with the target EMF fingerprint; and
provide the user device with an indication of the subset of objects.

10. The apparatus of claim 9, wherein the subset comprises those objects which are associated with the one or more reference EMF fingerprints that match with the target EMF fingerprint

11. The apparatus of claim 9, wherein the database entity is further caused to:
cause a reception, from the user device, of an indication of a target object, wherein the target object is associated with the target EMF fingerprint and the target object indicates the target EMF fingerprint, thereby enabling the database entity to acquire the target EMF fingerprint.

12. The apparatus of claim 9, wherein the database entity is further caused to:
arrange the subset according to a predetermined arrangement criterion, wherein the predetermined arrangement criterion comprises at least one of: relevancy on the basis of the match between the target EMF fingerprint and the reference EMF fingerprint, date of the reference EMF fingerprint, reliability of the reference EMF fingerprint; and
provide the user device with an indication of the arranged subset of objects.

13. The apparatus of claim 9, wherein the database entity is further caused to:
acquire reference metadata from at least one of the mobile devices; and
associate the acquired reference metadata with the at least one object indicated by the corresponding at least one mobile device.

14. The apparatus of claim 13, wherein the database entity is further caused to:
acquire an indication of a target metadata, wherein the target metadata is further used as one search key for the search; and
select the subset from the acquired objects, wherein the selection of the subset is further based on comparison between the indicated target metadata and the reference metadata associated with the objects.

15. The apparatus of claim 14, wherein the target metadata comprises at least one of the following: a time frame with which the reference EMF fingerprint is required to match, a reference to a social media network, duration and/or distance corresponding to the target EMF fingerprint, type of the objects to be retrieved.

16. The apparatus of claim 9, wherein the database entity is further caused to:
detect the geographical location in which the mobile device is at the moment when the at least one object is acquired;
associate each object with the corresponding geographical location;
acquire an indication of a target geographical area, wherein the target geographical area is further used as one search key for the search; and
select the subset from the acquired objects, wherein the selection of the subset is further based on which objects are associated with a geographical location within the indicated target geographical area.

17. An apparatus, comprising:
at least one processor and at least one memory including a computer program code, wherein the at least one memory and the computer program code are configured, with the at least one processor, to cause a mobile device at least to:
measure a reference Earth's magnetic field, EMF, fingerprint representing at least one of magnitude and direction of the EMF and provide the reference EMF fingerprint to a database entity; and
detect at least one object related to a location and/or environment corresponding to the reference EMF fingerprint from that mobile device, and provide an indication of the at least one object to the database entity, in order to allow the database entity to associate each object with the corresponding reference EMF fingerprint and maintain a database of the associations.

18. The apparatus of claim 17, wherein the reference EMF fingerprint is provided as part of a digital content file representing the detected object, and wherein the measurement of the reference EMF fingerprint is automatically performed.

19. An apparatus, comprising:
at least one processor and at least one memory including a computer program code, wherein the at least one memory and the computer program code are configured, with the at least one processor, to cause a user device at least to:
cause a transmission of an indication of a target Earth's magnetic field, EMF, fingerprint to a database entity, wherein the measured EMF fingerprint represents at least one of magnitude and direction of the EMF; and
cause a reception of an indication of a subset of objects, wherein the objects in the subset are associated with one or more reference EMF fingerprints that match, according to a predetermined criterion, with the transmitted target EMF fingerprint.

20. The apparatus of claim 19, wherein the user device is further caused to:
cause a transmission, to the database entity, of an indication of a target object, wherein the target object is associated with the target EMF fingerprint and the target object indicates the target EMF fingerprint.
